(19) United States
(12) Patent Application Publication
(10) Pub. No.: US 2006/0264184 A1
(43) Pub. Date: Nov. 23, 2006

(54) Method and apparatus for selecting a beam combination of multiple-input multiple-output antennas

(75) Inventors: Yingxue Li, Exton, PA (US); Inhyok Cha, Yardley, PA (US); Jungwoo Lee, South Plainfield, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/352,631

(22) Filed: Feb. 13, 2006

Related U.S. Application Data
(60) Provisional application No. 60/653,750, filed on Feb. 17, 2005.

(51) Int. Cl. H04B 1/02; H04M 1/00; H04B 7/02

(52) U.S. Cl. 455/101; 455/562.1

(57) ABSTRACT

A method and apparatus for selecting a beam combination of multiple-input multiple-output (MIMO) antennas are disclosed. A wireless transmit/receive unit (WTRUs) includes a plurality of antennas to generate a plurality of beams for supporting MIMO. At least one antenna is configured to generate multiple beams, such that various beam combinations can be produced and a desired beam combination selected for conducting wireless communication with another WTRU. A quality metric is measured with respect to each or subset of the possible beam combinations. A desired beam combination for MIMO transmission and reception is selected based on the quality metric measurements.

### CROSS REFERENCE TO RELATED APPLICATION

This application claims the benefit of U.S. provisional application No. 60/653,750 filed Feb. 17, 2005, which is incorporated by reference as if fully set forth.

### FIELD OF INVENTION

The present invention is related to a smart antenna technology in wireless communication systems. More particularly, the present invention is related to a method and apparatus for selecting a beam combination of multiple-input multiple-output (MIMO) antennas.

### BACKGROUND

Wireless communication systems are well known in the art. Generally, such systems comprise communication stations, which transmit and receive wireless communication signals between each other. Typically, a network of base stations, (or access points (APs)), is provided wherein each base station, (or AP), is capable of conducting concurrent wireless communications with appropriately configured mobile wireless transmit/receive units (WTRUs), as well as multiple appropriately configured base stations, (or APs). Some mobile WTRUs may alternatively be configured to conduct wireless communications directly between each other, i.e., without being relayed through a network via a base station, (or AP). This is commonly called peer-to-peer wireless communications. Where a mobile WTRU is configured to communicate directly with other mobile WTRUs it may itself also be configured as and function as a base station, (or AP). Mobile WTRUs can be configured for use in multiple networks, with both network and peer-to-peer communications capabilities.

The term “AP” as used herein includes, but is not limited to, a base station, a Node B, a site controller or other interfacing device in a wireless environment that provides mobile WTRUs with wireless access to a network with which the AP is associated. The term “mobile WTRU” as used herein includes, but is not limited to, a user equipment, a mobile station, a mobile subscriber unit, a pager or any other type of device capable of operating in a wireless environment. Such mobile WTRUs include personal communication devices, such as phones, video phones, and Internet ready phones that have network connections. In addition, mobile WTRUs include portable personal computing devices, such as personal data assistances (PDAs) and notebook computers with wireless modems that have similar network capabilities. Mobile WTRUs that are portable or can otherwise change location are referred to as mobile units.

One type of wireless system, called a wireless local area network (WLAN), can be configured to conduct wireless communications with mobile WTRUs equipped with WLAN modems that are also able to conduct peer-to-peer communications with similarly equipped mobile WTRUs. Currently, WLAN modems are being integrated into many traditional communicating and computing devices by manufacturers. For example, cellular phones, personal digital assistants, and laptop computers are being built with one or more WLAN modems.

Popular WLAN environments with one or more APs are built according to the IEEE 802 family of standards. Access to these networks usually requires user authentication procedures. Protocols for such systems are presently being standardized in the WLAN technology area such as the framework of protocols provided in the IEEE 802 family of standards.

FIG. 1 illustrates a conventional wireless communication environment in which mobile WTRUs 14 conduct wireless communications via a network station, in this case an AP 12 of a WLAN 10. As indicated by the heavy lined arrow in FIG. 1, the AP 12 is connected with other network infrastructure of the WLAN such as an access controller (AC). The AP 12 is shown as conducting communications with five mobile WTRUs 14. The communications are coordinated and synchronized through the AP 12. Such a configuration is also called a basic service set (BSS) within WLAN contexts.

In the wireless cellular context, one current standard in widespread use is known as Global System for Mobile Telecommunications (GSM). This is considered as a so-called Second Generation mobile radio system standard (2G) and was followed by its revision (2.5G). General Packet Radio Service (GPRS) and Enhanced Data for GSM Evolution (EDGE) are examples of 2.5G technologies that offer relatively high speed data service on top of (2G) GSM networks. Each one of these standards sought to improve upon the prior standard with additional features and enhancements. In January 1998, the European Telecommunications Standard Institute—Special Mobile Group (ETSI SMG) agreed on a radio access scheme for Third Generation Radio Systems called Universal Mobile Telecommunications Systems (UMTS). To further implement the UMTS standard, the Third Generation Partnership Project (3GPP) was formed in December 1998. 3GPP continues to work on a common third generational mobile radio standard. In addition to the 3GPP standards, 3GPP2 standards are being developed that use Mobile IP in a Core Network for mobility.

Much of the development of wireless communication systems has been motivated by the desire to reduce communication errors, improve range and throughput, and minimize costs. Most recent advances have been made possible by exploiting diversity in the time, frequency and code dimensions of communication signals. U.S. Pat. No. 5,614,914, which issued on Mar. 25, 1997 and is assigned to the assignee of the present invention, is an example of utilizing diversity to improve wireless communications.

Since the mid 1990s, the development of Multiple-Input Multiple-Output (MIMO) systems has led to increases in throughput without increasing transmission power or bandwidth, by exploiting the spatial diversity of the wireless communication channel. MIMO is one of the most promising techniques in wireless communications. Unlike traditional smart antenna techniques that aim to mitigate detrimental multipath fading and enhance robustness of a single data stream, MIMO takes advantage of multipath fading to transmit and receive multiple data streams simultaneously. Theoretically, the capacity in a MIMO system increases linearly with the number of transmit and receive antennas. MIMO is being considered by numerous wireless data communication standards, such as IEEE 802.11n and 3GPP wideband code division multiple access (WCDMA).

For a given number of transceiver chain, when spatial multiplexing is used, diversity gain decreases. Therefore, data link becomes less reliable and system may fall back to single data stream mode. To improve link quality for multiple data streams, more transceiver chains may be used. However, this results in higher cost. The present invention achieves spatial diversity in a MIMO system without adding extra transceiver chains.

### SUMMARY

The present invention is related to a method and apparatus for selecting a beam combination of MIMO antennas. A WTRU, (including a base station, an AP and a mobile WTRU), includes a plurality of antennas to generate a plurality of beams for supporting MIMO. At least one antenna is configured to generate multiple beams, such that a beam combination may be selected. A quality metric is measured on each or subset of the beams or beam combinations while switching a beam combination. A desired beam combination for MIMO transmission and reception is selected based on the quality metric.

In accordance with one preferred method of wireless communication in a MIMO wireless communication system, a first WTRU is provided with a plurality of antennas. At least one of the antennas is capable of producing a plurality of beams such that the first WTRU is capable of producing a plurality of different beam combinations for MIMO wireless communication. The first WTRU forms a beam combination using the plurality of antennas in connection with a MIMO wireless communication with a second WTRU. The first WTRU measures a selected quality metric with respect to the beam combination. The first WTRU then repeats the forming and measuring steps with respect to one or more different beam combinations to produce a plurality of quality metric measurements. The first WTRU then selects a desired beam combination for MIMO wireless communications with the second WTRU based on the quality metric measurements. Either the first or the second WTRU can be a base station or an AP of a WLAN. Alternatively, the method can be performed with respect to a MIMO wireless communication with respect to WTRUs conducting wireless communication in an ad hoc network.

Preferably the method is repeated periodically to select a new desired beam combination based on updated quality metric measurements. In this regard, a quality metric is preferably monitored while conducting MIMO wireless communication using the selected desired beam combination and the method is repeated to select an updated desired beam combination when the monitored quality metric changes by a predetermined threshold amount.

The measuring of a quality metric preferably includes measuring of one or more metrics of the group of metrics including channel estimation, a signal-to-noise and interference ratio (SNIR), a received signal strength indicator (RSSI), a short-term data throughput, a packet error rate, a data rate and an operation mode of the WTRU.

Where the WTRU uses a spatial multiplexing operation mode, the quality metric measured is preferably a SNIR and the WTRU preferably uses a SNIR of a weakest data stream as a beam selection criteria. Alternatively, where the WTRU uses a spatial multiplexing operation mode, the quality metric can be a singular value of a channel matrix and the WTRU then preferably uses a minimum singular value of a channel matrix as a beam selection criteria.

Where the WTRU uses a transmit diversity operation mode, the measuring of a quality metric preferably includes measuring of a combined SNIR of each of the beam combinations, and the WTRU preferably uses the combined SNIR as beam selection criteria. One alternative where the WTRU uses a transmit diversity operation mode, the measuring of a quality metric can include computing a Frobenius norm of a channel matrix, and the WTRU uses the Frobenius norm of a channel matrix as beam selection criteria.

In accordance with another embodiment, the WTRU is provided with a a plurality of antennas, and the WTRU performs radio frequency (RF) beamforming for generating a plurality of beams. The WTRU measures a quality metric on each of the beams and selects a subset of the beams in connection with a MIMO wireless communication with another WTRU based on the quality metric.

In another aspect of the invention, a WTRU configured for MIMO wireless communication is provided. The WTRU comprises a plurality of antennas, an antenna beam selection control component, a transceiver and a beam selector. At least one antenna is configured to generate multiple beams such that the WTRU is capable of producing a plurality of different beam combinations for MIMO wireless communication. The antenna beam selection control component is configured to control the antennas to produce selected beam combinations. The transceiver is configured to process data for transmission and reception via the antennas. The transceiver includes a quality metric measurement unit configured to measure a quality metric of wireless MIMO communication signals. The beam selector is coupled to the antenna beam selection control component and the transceiver and configured to select a desired beam combination for MIMO transmission and reception based on the quality metric measurements.

The antennas may be switched parasitic antennas (SPAs) or phased array antennas. Alternatively, each of the antennas may comprise multiple omni-directional antennas. Preferably, the antennas are configured to ensure that overlapping of the beams generated by the antennas is minimized.

Preferably, the beam selector is configured to periodically select an updated desired beam combination based on updated quality metric measurements. In this regard, the transceiver is configured to monitor a quality metric during MIMO wireless communication using the currently selected beam combination and the beam selector is configured to trigger selection of a new desired beam combination when the monitored quality metric changes by a predetermined threshold amount.

The quality metric measurement unit is configured to measure one or more quality metrics of a group of quality metrics including channel estimation, a SNIR, a RSSI, a short-term data throughput, a packet error rate, a data rate and an operation mode of the WTRU.

The WTRU may be configured to use a spatial multiplexing operation mode. In this case, the quality metric measurement unit is configured to measure a SNIR and the beam selector is configured to use an SNIR of a weakest data stream as a beam selection criteria. Alternatively, the quality metric measurement unit may be configured to measure a singular value of a channel matrix, and the beam selector may be configured to use a minimum singular value of a channel matrix as a beam selection criteria.

The WTRU may be configured to use a transmit diversity operation mode. In such case, the quality metric measurement unit is configured to measure a combined SNIR of each of the beam combinations, and the beam selector is configured to use the combined SNIR as beam selection criteria. Alternatively, the quality metric measurement unit may be configured to measure a Frobenius norm of a channel matrix, and the beam selector may be configured to use the Frobenius norm of a channel matrix as beam selection criteria.

The WTRU may be a base station of a wireless network, an AP of a WLAN or a mobile WTRU. The WTRU may be configured to conduct wireless communication between WTRUs in an ad hoc network.

In accordance with another embodiment, the WTRU comprises a plurality of antennas, an RF beamformer, a beam selection control component, a transceiver and a beam selector. The RF beamformer is configured to perform an RF beamforming for generating a plurality of beams. The beam selection control component selects a subset of beams among the generated beams. The transceiver processes data for transmission and reception via the antennas. The transceiver includes a quality metric measurement unit configured to measure a quality metric on each of the beams. The beam selector is coupled to the beam selection control component and the transceiver and is configured to select a subset of the beams for MIMO transmission and reception based on the quality metric measurements.

### BRIEF DESCRIPTION OF THE DRAWINGS

FIG. 1 is a system overview diagram illustrating conventional wireless communication in a WLAN.

FIG. 2 is a block diagram of a system including an AP and a WTRU in accordance with the present invention.

FIG. 3 shows an exemplary beam pattern and orientation generated by the antennas in accordance with the present invention.

FIG. 4 is a flow diagram of a process for selecting a beam combination of MIMO antennas in accordance with the present invention.

FIG. 5 is a block diagram of a WTRU in accordance with another embodiment of the present invention.

### DETAILED DESCRIPTION OF THE PREFERRED EMBODIMENTS

Hereinafter, the terminology “WTRU” includes a base station, a mobile WTRU and their equivalents, such as an AP, a Node B, a site controller, a user equipment, a mobile station, a mobile subscriber unit, a pager, which may or may not be capable of communicating in an ad hoc network.

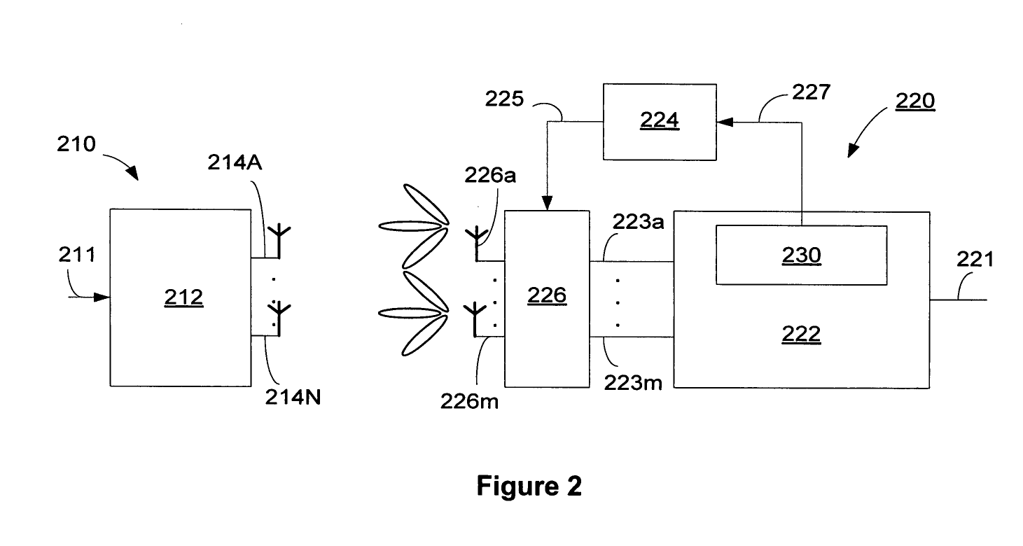

FIG. 2 is a block diagram of a wireless communication system including a first WTRU 210 and a second WTRU 220 in accordance with the present invention. Hereinafter, the present invention will be explained with reference to downlink transmission from an AP as the first WTRU 210 to the WTRU 220. However, the present invention is equally applicable to both uplink and downlink transmissions where either WTRU 210 or WTRU 220 is a base station as well as for configurations where WTRU 210 is in direct communication with WTRU 220 in an ad hoc network.

The AP 210 includes a transceiver 212 and a plurality of antennas 214A-214N. The WTRU 220 includes a transceiver 222, a beam selector 224 and a plurality of antennas 226a-226m. At least one of the antennas 226a-226m generates multiple beams. A beam combination is selected by the beam selector 224 for MIMO transmission and reception. The selected beam combination is generated by the antennas via antenna beam selection control circuitry 226 in accordance with a control signal output via a coupling 225 from the beam selector 224. The beam selector 224 selects a particular beam combination based on quality metric generated by a quality metric measurement unit 230 in the transceiver 222 as explained in detail hereinafter. The WTRU components of the present invention may be incorporated into an integrated circuit (IC) or be configured in a circuit comprising a multitude of interconnecting components.

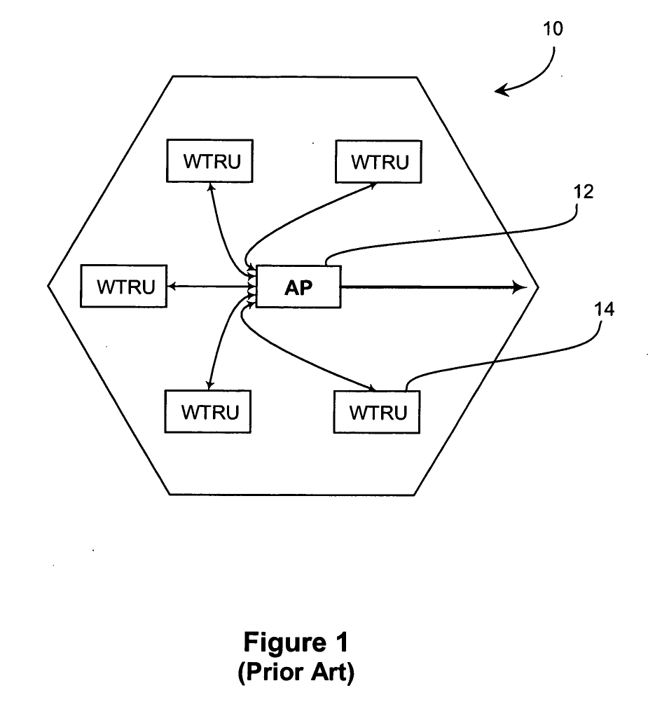

For simplicity, FIG. 2 illustrates a WTRU 220 equipped with multiple antennas, each of which generates three (3) beams. However, the configuration shown in FIG. 1 is provided as an example, not as a limitation. Any number of beams may be generated by any of the antennas provided that at least one of the antennas is configured to generate more than one beam. The AP 210 may also include a beam selector to control beam generation and selection like the WTRU 220.

The antennas 226a-226m may be switched parasitic antennas (SPAs), phased array antennas, or any type of directional beam forming antennas. A SPA is compact in size, which makes it suitable for WLAN devices. If a SPA is used, a single active antenna element in conjunction with one or more passive antenna elements may be used. By adjusting impedances of the passive antenna elements, the antenna beam pattern may be adjusted and the impedance adjustment may be performed by controlling a set of switches connected to the antenna elements.

Alternatively, the antennas may be composites including multiple antennas which may all be omni-directional antennas. For example, three omni-directional antennas having a selected physical spacing may be used for each of the antennas 216a-216m and the omni-directional antennas may be switched on and off in accordance with a control signal from the beam selector 224 to define different beam combinations.

Information bits received via an input 211 are processed by the AP transceiver 212 and resulting radio frequency (RF) signals are transmitted through the antennas 214A-214N. The transmitted RF signals are received by the antennas 226a-226m of the WTRU 220 after propagating through wireless medium. The respective received signals are conveyed via data paths 223a-223m to the WTRU transceiver 222 which processes the signal and outputs data via output 221.

Unlike a prior art MIMO system, where each antenna only has a single fixed beam pattern, at least one of the antennas 226a-226m is capable of generating multiple beams. In the example of FIG. 2, antenna 226a generates three beams a1, a2, a3 and antenna 226m generates three beams m1, m2, m3. The generated beams may all be directional beams, as shown in FIG. 2, or may include an omni-directional beam.

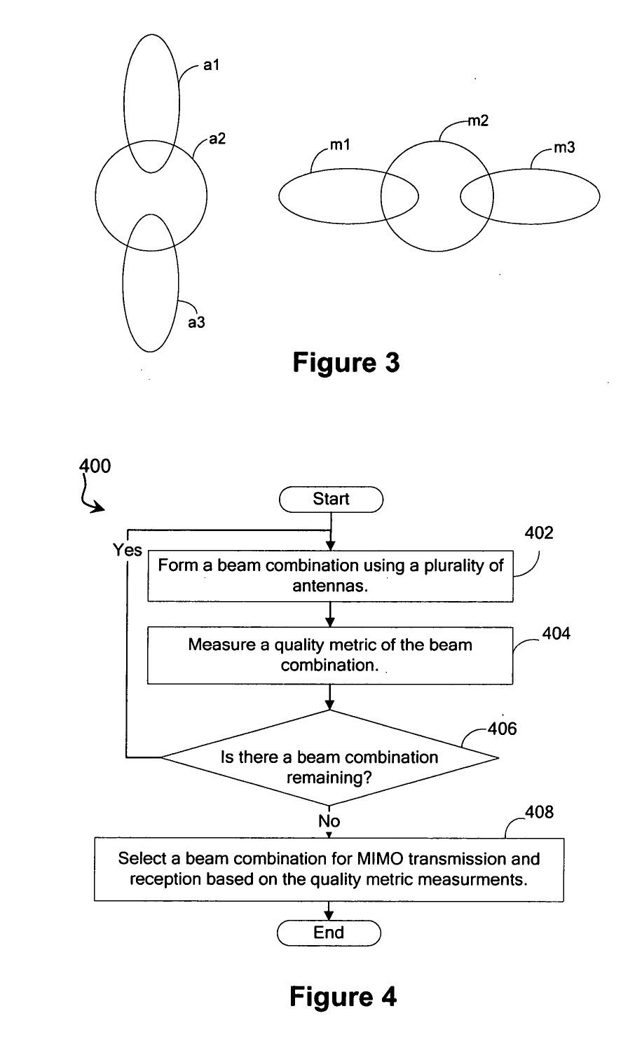

To maximize benefit of beam selection, it is preferable to minimize beam overlapping of the beams generated by adjacent antennas. FIG. 3 shows an exemplary beam pattern and orientation. One antenna, such as antenna 226a, generates an omni-directional beam a2 and two directional beams a1, a3, and another antenna, such as antenna 226m, generates an omni-directional beam m2 and two directional beams m1, m3. The orientation of the beams a1, a3 and the beams m1, m3 are deviated, for example, 90° as shown in FIG. 3, each other in azimuth so that overlapping of the directional beams a1, a3, m1, m3 is minimized.

During operation, the quality metric measurement unit 230 measures a selected quality metric on each of antenna beams or beam combinations, (or subset of beam combinations), and outputs a quality metric measurement data via line 227 to the beam selector 224. The beam selector 224 chooses a desired beam combination for data communications with the AP 210 based on the quality metric measurement.

Various quality metrics can be used for determining a desired beam selection. Physical layer, medium access control (MAC) layer or upper layer metrics are suitable. Preferred quality metrics include, but not limited to, channel estimations, a signal-to-noise and interference ratio (SNIR), a received signal strength indicator (RSSI), a short-term data throughput, a packet error rate, a data rate, a WTRU operation mode, or the like.

In implementing MIMO, the WTRU 220 may operate in either a spatial multiplexing mode or a spatial diversity mode. In the spatial multiplexing mode, the AP 210 transmits multiple independent data streams to maximize a data throughout. Typically, an M×N channel matrix H is obtained of the form:

$$H = [ \begin{matrix}{h}_{Aa} & ⋯ & {h}_{Na} \\ ⋯ & & ⋯ \\ {h}_{Am} & ⋯ & {h}_{Nm}\end{matrix} ]$$

where the subscripts of the elements h represent contributions attributable to each antenna pairings between the AP antennas 214A-214N and the antennas 226a-226m of the WTRU 220.

While in the spatial diversity mode, the AP 210 transmits a single data stream via multiple antennas. Depending on the operation mode, the WTRU 220 is configured to select an appropriate quality metric or a combination of quality metrics to utilize in the selection of a desired beam combination.

The beam combination selection can be based on all possible beam combinations or may be made based on a limited subset of beam combinations. For example, where multiple antennas are capable of generating both directional and omni-directional beams, selectable beam combinations could be limited to combinations where only one of the antennas generates an omni-directional beam.

If the WTRU 220 operates in the spatial multiplexing mode and a channel matrix for each beam combination is obtained reliably, the WTRU 220 preferably performs singular value decomposition (SVD) on the channel matrixes and selects a beam combination based on the singular values of the channel matrixes. Since a channel capacity is determined by the smallest singular value of the channel matrix, the WTRU 220 compares the smallest singular values of the channel matrixes and selects the beam combination associated with the channel matrix having the largest singular value among the smallest singular values of the channel matrixes.

If in the example of FIG. 2 there are only two AP antennas 224A, 224N and two WTRU antennas 226a, 226m where WTRU antenna 226a can generate three beams a1, a2, a3 and WTRU antenna 226m can generates three beams m1, m2, m3, as illustrated in FIG. 3, nine (9) 2×2 channel matrixes H are generated of the form:

$$H = [ \begin{matrix}{h}_{Aai} & {h}_{Nai} \\ {h}_{Amj} & {h}_{Nmj}\end{matrix} ] ,$$

where the subscripts of the elements h represent contributions attributable to each antenna pairings between the AP antennas 214A, 214N and a beam combination by the WTRU antennas for WTRU antenna 226a generating beam ai, where ai is beam a1, a2 or a3 and the WTRU antenna 226m generating beam mj, where mj is beam m1,m2 or m3.

SVD is performed on each channel matrix H and two singular values are obtained for each channel matrix H. Preferably, the WTRU 220 compares the smallest singular values of the nine channel matrixes and selects the channel matrix having the largest such value.

With respect to this specific example, one potential limitation to the selection criteria would be to not permit the combination of beams where both WTRU antennas generate omni-directional beams. In accordance with the example of FIG. 3, this would occur where antenna 226a generates beam a2 and antenna 226m generates beam m2. With a limitation to exclude this combination, only eight of the nine channel matrixes would preferably be generated and evaluated to select the desired combination, since the combination corresponding to beam combination a2:m2 would be excluded.

Similarly, with respect to this specific example, another potential limitation to the selection criteria would be to require the combination of beams to be where at least one of the WTRU antennas generates an omni-directional beam. In accordance with the example of FIG. 3, this would occur where either antenna 226a generates beam a2 or antenna 226m generates beam m2. With a limitation to require this type of combination, only five of the nine channel matrixes would preferably be generated and evaluated to select the desired combination, since the combinations corresponding to beam combinations a1:m1; a1:m3; a3:m1; a3:m3 would be excluded.

Similarly, with respect to this specific example, another potential limitation to the selection criteria would be to require the combination of beams to be where only directional beams are used. In accordance with the example of FIG. 3, this would occur where neither antenna 226a generates beam a2 nor antenna 226m generates beam m2. With a limitation to require this type of combination, only four of nine channel matrixes would be preferably generated and evaluated to select the desired combination, since only the combination corresponding to beam combinations a1:m1, a1:m3, a3:m1, a3:m3 would be included.

Alternatively, a time-adaptive selection of a sub-set of the beam combinations may be used based on running statistics. In accordance with the example of FIG. 3, this would occur where, at time To upon completion of a full search of all beam combinations, not only the then-current best beam-combination, (e.g., a1:m1), would be selected, but also a sub-set of candidate beam combinations with beam combinations, (e.g., {a1:m1, a1:m3, a3:m1}), would be created for later use. Any further search for the best beam to be performed during the time period [T₀, T₀+T], where T can be an adaptable time-period parameter, would be limited to the chosen subset, (e.g., {a1:m1, a1:m3, a3:m1}). The selection criteria of this sub-set of beam combinations could be the same criteria that are used for the selection of the best beam combination. During the period of time [T₀, T₀+T], only the beam-combinations in the subset, (e.g., {a1:m1, a1:m3, a3:m1}), would be tested whenever a new beam-combination search takes place. The time-duration parameter T could be a relatively large value. At time T₀+T, a new full-search of all beam combinations would take place, the new best beam combination, (e.g., a3:m1), would be chosen as well as a new subset of beam combinations, (e.g., {a3:m1, a3:m3, a1:m3}), would be formed. Then, any new beam search possibly to be performed in the next time period [T₀+T, T₀+2T] would be limited to the new sub-set of beam combinations. The scheme is useful in limiting the size of the search space for most beam combination searches by use of the time-adaptive selection of the beam combination sub-sets.

The present invention is not limited to two antennas having three beams as discussed above in the preceding specific example. As will be readily apparent to those of skill in the art, an M×N channel matrix is readily obtained for any values of N and M which represent the number of respective antennas. The number of combinations to be considered is dependent on the number of beams which each of the WTRU's N antennas is capable, limited by any selected criteria of permissible or excluded antenna beam combinations.

If the WTRU 220 operates in a spatial diversity mode, the WTRU 220 preferably generates a channel matrix for each beam combination and calculates Frobenius norm of each channel matrix and selects a beam combination associated with the channel matrix having the largest Frobenius norm. Alternatively, a combined SINR of each beam combination may be used for selection criteria.

If the channel matrix is not available, the WTRU 220 may collect short term average throughput corresponding to each beam combination as signal quality metrics and select a beam combination such that the short term average throughput is maximized.

As stated hereinbefore, the AP 210 may also include a beam selector and an antenna configured to generate multiple beams. It is possible for each station, AP 210 and WTRU 220, to concurrently attempt to select a desired beam combination for its own use in accordance with the invention as described above. However, one preferred alternative is for the WTRU 220 to first select a desired beam combination using the present invention as described above and then for the AP 210 to select a desired combination. This can be done through signaling from the WTRU 220 to the AP 210 or merely configuring the AP 210 with a delay in performing the selection process to allow the WTRU 220 to complete its selection before the AP 210 selects a desired antenna beam combination. Additionally, the WTRU 220 could be configured to update its selection of a desired antenna beam combination, after such a selection by the AP 210 has been performed. Alternatively, the AP 210 can be configured to make the first selection of a desired antenna beam combination.

The WTRU may be equipped with multiple transceivers and each of transceivers may be coupled to an antenna. At least one antenna is configured to generate more than one beam, so that the number of simultaneously available beams is equal to number of transceivers and the total number of antenna beams is greater than the number of transceivers.

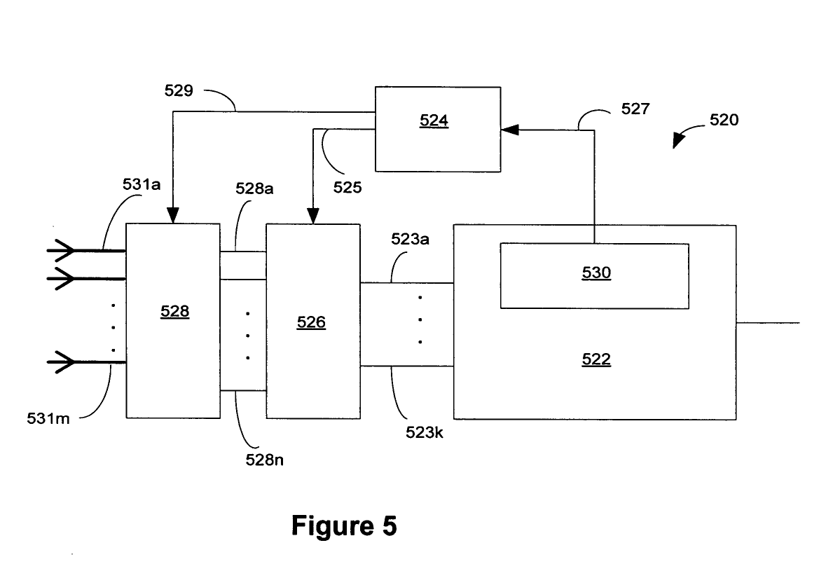

FIG. 5 is a block diagram of a WTRU 520 in accordance with another embodiment of the present invention. The WTRU 520 comprises a transceiver 522 including a quality metric measurement unit 530, a beam selector 524, a beam selection control circuitry 526, a radio frequency (RF) beamformer 528 and a plurality of antennas 531a-531m. The RF beamformer 528 is provided between the antennas 531a-531m and the beam selection control circuitry 526 to form multiple beams from the received signals via the antennas 531a-531m. The antennas 531a-531m may be omni-directional antennas or directional antennas. Multiple data streams are then output from the RF beamformer 528. Each data stream corresponds to a particular beam generated by the RF beamformer 528. The number of data streams is not required to be equal to the number of antennas 531a-531m and may be more or less than the number of antennas 531a-531m. The beams may be fixed beams or may be adjustable in accordance with a control signal 529 (optional). The multiple data streams are fed to the beam selection control circuitry 526 via data paths 528a-528n where one path is provided for each data stream. The beam selector 524 sends a control signal 525 to the beam selection control circuitry 526 to select a subset of the data streams among the data streams for MIMO communication with another WTRU (not shown) that is currently in communication. To make a data stream selection, (i.e., a beam selection), signal quality metrics for each data stream are measured by the quality metric measurement unit 530 and sent to the beam selector 524 via a line 527. The best beam combination is then selected by the beam selector 524 based on the signal quality metrics.

FIG. 4 is a flow diagram of a process 400 for selecting a beam combination of MIMO antennas in accordance with the present invention based on a selected quality metric or combination of metrics. A beam combination of a plurality of beams is formed using a plurality of antennas (step 402). Each antenna is configured to generate at least one beam. A selected quality metric is then measured with respect to the beam combination (step 404). It is determined whether another beam combination is remaining (step 406). If so, the process 400 returns to step 402 and steps 402 and 404 are repeated. If there is no beam combination left, the process 400 proceeds to step 408. A desired beam combination for MIMO transmission and reception is then selected based on comparison of the quality metric measurements (step 408).

During MIMO communication with the selected beam combination, the WTRU 220 may periodically switch a beam combination to measure the quality metrics on each or a subset of the beam combinations and select a new optimum beam combination based on the updated quality metric. The beam selection procedure is preferably triggered when a quality metric on a currently selected beam combination changes more than a predetermined threshold. For example, when the WTRU 220 moves from one location to another, the channel quality on a currently selected beam combination may degrade and channel quality with respect to another beam combination may become better. Preferably, when the quality metric measured for a currently selected beam combination is degraded or enhanced by more than the predetermined threshold, the beam selection procedure is triggered to find a new optimum beam combination. Preferably, the antenna beam switching and the quality metrics measurements are performed in a synchronized manner.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method of wireless communication in a multiple-input multiple-output (MIMO) wireless communication system comprising:
(a) providing a first wireless transmit/receive unit (WTRU) having a plurality of antennas where at least one of the antennas is capable of producing a plurality of beams such that the WTRU is capable of producing a plurality of different beam combinations for MIMO wireless communications;
(b) the first WTRU forming a beam combination using the plurality of antennas in connection with a MIMO wireless communication with a second WTRU;
(c) the first WTRU measuring a selected quality metric with respect to the beam combination;
(d) the first WTRU repeating steps (b) and (c) with respect to one or more different beam combinations to produce a plurality of quality metric measurements; and
(e) the first WTRU selecting a desired beam combination for MIMO wireless communications with the second WTRU based on the quality metric measurements.

2. The method of claim 1 where the second WTRU is a base station wherein steps (b) through (e) are performed with respect to a MIMO wireless communication with the base station.

3. The method of claim 1 where the second WTRU is an Access Point (AP) of a wireless local area network (WLAN) wherein steps (b) through (e) are performed with respect to a MIMO wireless communication with the AP.

4. The method of claim 1 where the first WTRU is a base station and the second WTRU is a mobile WTRU wherein steps (b) through (e) are performed with respect to a MIMO wireless communication between the base station and the mobile WTRU.

5. The method of claim 1 where the first WTRU is an Access Point (AP) of a wireless local area network (WLAN) and the second WTRU is a mobile WTRU wherein steps (b) through (e) are performed with respect to a WLAN MIMO wireless communication between the AP and the mobile WTRU.

6. The method of claim 1 wherein steps (b) through (e) are performed with respect to a wireless communication between the first WTRU and the second WTRU in an ad hoc network.

7. The method of claim 1 wherein steps (b) through (e) are repeated periodically to select a new desired beam combination based on updated quality metric measurements.

8. The method of claim 1 further comprising monitoring a quality metric while conducting MIMO wireless communication using the selected desired beam combination and repeating steps (b) through (e) to select an updated desired beam combination when the monitored quality metric changes by a predetermined threshold amount.

9. The method of claim 1 wherein measuring of a quality metric includes measuring of one or more metrics of the group of metrics including channel estimation, a signal-to-noise and interference ratio (SNIR), a received signal strength indicator (RSSI), a short-term data throughput, a packet error rate, a data rate and an operation mode of the WTRU.

10. The method of claim 1 wherein the WTRU uses a spatial multiplexing operation mode, the quality metric measured is a signal-to-noise and interference ratio (SNIR) and the first WTRU uses an SNIR of a weakest data stream as a beam selection criteria for step (e).

11. The method of claim 1 wherein the WTRU uses a spatial multiplexing operation mode, the quality metric is a singular value of a channel matrix and the WTRU uses a minimum singular value of a channel matrix as beam selection criteria for step (e).

12. The method of claim 1 wherein the WTRU uses a transmit diversity operation mode, the measuring of a quality metric includes measuring of a combined signal-to-noise and interference ratio (SNIR) of each of the beam combinations, and the WTRU uses the combined SNIR as beam selection criteria for step (e).

13. The method of claim 1 wherein the WTRU uses a transmit diversity operation mode, the measuring of a quality metric includes computing a Frobenius norm of a channel matrix, and the WTRU uses the Frobenius norm of a channel matrix as beam selection criteria for step (e).

14. The method of claim 1 wherein a subset of beam combinations is selected and a new desired beam combination is selected among the subset of beam combinations for a predetermined period of time.

15. A method of wireless communication in a multiple-input multiple-output (MIMO) wireless communication system comprising:
(a) providing a first wireless transmit/receive unit (WTRU) having a plurality of antennas;
(b) the first WTRU performing radio frequency (RF) beamforming for generating a plurality of beams;
(c) the first WTRU measuring a quality metric on each of the beams; and
(d) the first WTRU selecting a subset of the beams in connection with a MIMO wireless communication with a second WTRU based on the quality metric.

16. A wireless transmit/receive unit (WTRU) configured for multiple-input multiple-output (MIMO) wireless communication, the WTRU comprising:
a plurality of antennas configured to generate a plurality of beam combinations, at least one antenna being configured to generate multiple beams;
an antenna beam selection control component configured to control the antennas to produce selected beam combinations;
a transceiver configured to process data for transmission and reception via the antennas, the transceiver including a quality metric measurement unit configured to measure a quality metric of wireless MIMO communication signals; and
a beam selector coupled to the antenna beam selection control component and the transceiver and configured to select a desired beam combination for MIMO transmission and reception based on the quality metric measurements.

17. The WTRU of claim 16 wherein the antennas are switched parasitic antennas (SPAs).

18. The WTRU of claim 16 wherein the antennas are phased array antennas.

19. The WTRU of claim 16 wherein each of the antennas comprises multiple omni-directional antennas.

20. The WTRU of claim 16 wherein the antennas are configured to ensure that overlapping of the beams generated by the antennas is minimized.

21. The WTRU of claim 16 wherein the beam selector is configured to periodically select an updated desired beam combination based on updated quality metric measurements.

22. The WTRU of claim 16 wherein the transceiver is configured to monitor a quality metric during MIMO wireless communication and the beam selector is configured to trigger selection of a new desired beam combination when the monitored quality metric changes by a predetermined threshold amount.

23. The WTRU of claim 16 wherein the quality metric measurement unit is configured to measure one or more quality metrics of a group of quality metrics including channel estimation, a signal-to-noise and interference ratio (SNIR), a received signal strength indicator (RSSI), a short-term data throughput, a packet error rate, a data rate and an operation mode of the WTRU.

24. The WTRU of claim 16 wherein the WTRU is configured to use a spatial multiplexing operation mode, the quality metric measurement unit is configured to measure a signal-to-noise and interference ratio (SNIR) and the beam selector is configured to use an SNIR of a weakest data stream as a beam selection criteria.

25. The WTRU of claim 16 wherein the WTRU is configured to use a spatial multiplexing operation mode, the quality metric measurement unit is configured to measure a singular value of a channel matrix, and the beam selector is configured to use a minimum singular value of a channel matrix as a beam selection criteria.

26. The WTRU of claim 16 wherein the WTRU is configured to use a transmit diversity operation mode, the quality metric measurement unit is configured to measure a combined signal-to-noise and interference ratio (SNIR) of each of the beam combinations, and the beam selector is configured to use the combined SNIR as beam selection criteria.

27. The WTRU of claim 16 wherein the WTRU is configured to use a transmit diversity operation mode, the quality metric measurement unit is configured to measure a Frobenius norm of a channel matrix, and the beam selector is configured to use the Frobenius norm of a channel matrix as beam selection criteria.

28. The WTRU of claim 16 wherein the beam selector is configured to select a subset of beam combinations and select a new desired beam combination among the subset of beam combinations for a predetermined period of time.

29. The WTRU of claim 16 wherein the WTRU is configured as a base station of a wireless network.

30. The WTRU of claim 16 where the WTRU is configured as an Access Point (AP) of a wireless local area network (WLAN).

31. The WTRU of claim 16 where the WTRU is a mobile WTRU.

32. The WTRU of claim 16 wherein the WTRU is configured to conduct wireless communication between WTRUs in an ad hoc network.

33. A wireless transmit/receive unit (WTRU) configured for multiple-input multiple-output (MIMO) wireless communication, the WTRU comprising:
a plurality of antennas;
a radio frequency (RF) beamformer configured to perform an RF beamforming for generating a plurality of beams;
a beam selection control component configured to select a subset of beams among the generated beams;
a transceiver configured to process data for transmission and reception via the antennas, the transceiver including a quality metric measurement unit configured to measure a quality metric on each of the beams; and
a beam selector coupled to the beam selection control component and the transceiver and configured to select a subset of the beams for MIMO transmission and reception based on the quality metric measurements.
